(19) United States
(12) Patent Application Publication
(10) Pub. No.: US 2011/0318563 A1
(43) Pub. Date: Dec. 29, 2011

(54) NANOWIRE STRUCTURE AND METHOD FOR MAKING SAME

(75) Inventor: CHIA-LING HSU, Tu-Cheng (TW)

(73) Assignee: HON HAI PRECISION INDUSTRY CO., LTD., Tu-Cheng (TW)

(21) Appl. No.: 12/860,922

(22) Filed: Aug. 22, 2010

(30) Foreign Application Priority Data
Jun. 23, 2010 (TW) 99120345

(51) Int. Cl. B32B 5/08; B32B 37/10; B32B 37/16; B82Y 40/00; B82Y 30/00

(52) U.S. Cl. 428/297.7; 156/230; 977/762; 977/882

(57) ABSTRACT

A nanowire structure includes a thermoplastic polymer layer defining a surface; and a nanowire film formed on the surface of the thermoplastic polymer layer. The nanowire film includes nanowires laid directly on the surface with the nanowires oriented along a substantially same direction on the surface. A method for making the nanowire structure includes a spin coating step and a heating step for forming the thermoplastic polymer layer, and a rolling step for allowing the nanowires to be oriented on the thermoplastic polymer layer.

### BACKGROUND

1. Technical Field

The present disclosure relates to a nanowire structure and a method for making same.

2. Description of Related Art

Nanowire structures having nanowires have a variety of applications such as in sensors and in transistors, because the nanowires show excellent mechanical characteristic, quantum effect, and high surface to volume ratio. Such nanowires can have metallic, semi-metallic and polymer, characteristics according to the material characteristics thereof.

Nanowires are usually grown on a substrate. Due to the size of nanowires, it is difficult to allow the nanowires to arrange substantially along a same direction after being collected from the substrate or being transferred from one substrate to another substrate.

Dielectrophoresis, micro-fluid channel and blown film extrusion methods have been used to collect or transfer the nanowires. However, these methods each take a substantial amount of time.

What is needed, therefore, is a nanowire structure and a method for making the same, which can overcome the above shortcomings.

### BRIEF DESCRIPTION OF THE DRAWINGS

Many aspects of the present nanowire structure and method can be better understood with reference to the following drawings. The components in the drawings are not necessarily drawn to scale, the emphasis instead being placed upon clearly illustrating the principles of the present nanowire structure and method. Moreover, in the drawings, like reference numerals designate corresponding parts throughout the several views.

FIG. 1 is a schematic view of a nanowire structure in accordance with an exemplary embodiment, the nanowire structure includes a thermoplastic polymer layer and a nanowire film.

FIG. 2 shows steps of a method for making the nanowire structure of FIG. 1.

FIG. 3 is a scanning picture of the nanowire film.

### DETAILED DESCRIPTION

Embodiments of the present nanowire structure and method will now be described in detail below and with reference to the drawings.

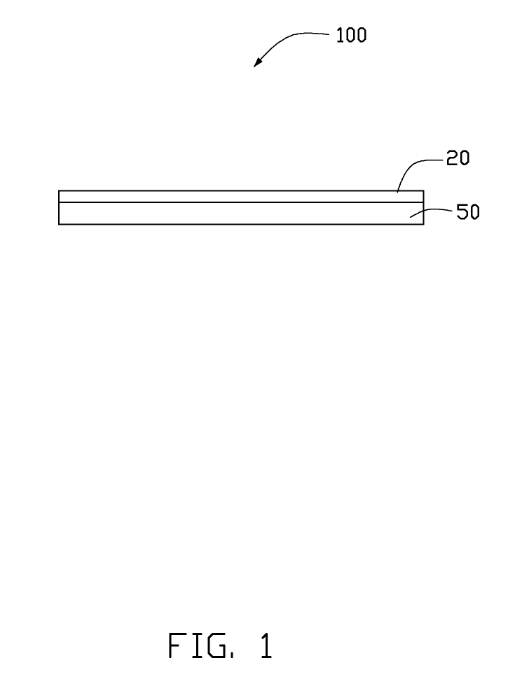

Referring to FIG. 1, an exemplary nanowire structure 100 includes a thermoplastic polymer layer 50 defining a surface 52, and a nanowire film 20 arranged on the surface 52 of the thermoplastic polymer layer 50.

The thermoplastic polymer layer 50 contains or can be made fully from polymethyl methacrylate (PMMA). The thermoplastic polymer layer 50 is transparent.

The nanowire film 20 includes a plurality of nanowires. The nanowires are solid, and a diameter of each of the nanowires is in a range of about 1 nm to about 100 nm. The nanowires can be metallic or semi-metallic nanowires. The metallic nanowires can be made of, for example, silver (Ag) nano particles, nickel (Ni) nano particles, or zinc oxide (ZnO) nano particles. The semi-metallic nanowires can be made of silicon (Si) particles.

The nanowires are laid directly on the surface 52 of the thermoplastic polymer layer 50. Lengthwise directions of the nanowires are along a substantially same direction on the surface 52, i.e, the nanowires are oriented along a substantially same direction.

The nanowire film 20 can further be separated from the thermoplastic polymer layer 50.

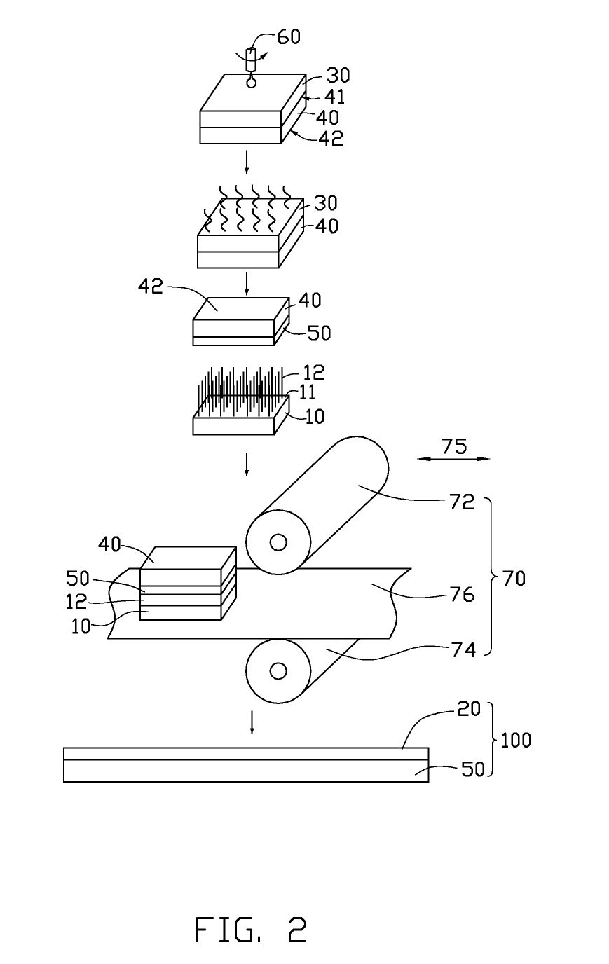

Referring to FIG. 2, a method for making the nanowire structure 100 includes the following steps. First, a first substrate 10 defining a first surface 11 is provided. Then, a nanowire array is grown perpendicularly on the first surface 11. The nanowire array includes a number of nanowires 12.

Second, a second substrate 40 defining a second surface 41 and an opposite third surface 42 is provided. Then, a thermoplastic polymer solution 30 is dropped on the second surface 41 using a spin coating apparatus 60. The thermoplastic polymer solution 30 having an organic solvent and a thermoplastic polymer as a solute. The organic solvent can be toluene. The second substrate 40 is then heated to vaporize the organic solvent, thereby obtaining a thermoplastic polymer layer 50 on the second surface 41.

The order of preparation of the above first and second substrates 10 and 40 can be exchanged. Then the first substrate 10 and the second substrate 40 are combined together to adhere the nanowires 12 to the thermoplastic polymer layer 50. Before the combining step, if the thermoplastic polymer layer 50 is hard, the thermoplastic polymer layer 50 can be heated to be soft.

Next, the combined first and second substrates 10, 40 is compressed by a squeezing roller pair 70. The squeezing roller pair 70 includes a first roller 72, a second roller 74, and delivering belt 76 located between the first and second rollers 72 and 74. The first and second rollers 72 and 74 can rotate simultaneously, and move along a same direction along a straight line arrow 75. The second roller 74 supports the delivering belt 76. The combined first and second substrates 10 and 40 are placed on the delivering belt 76, and the first roller 72 is applied on the third surface 42 of the second substrate 40 for rolling the third surface 42 along the straight line arrow 75. By this way, the nanowires 12 can be pushed over and be fully adhered to the thermoplastic polymer layer 50, thereby forming the nanowire film 20 on the thermoplastic polymer layer 50.

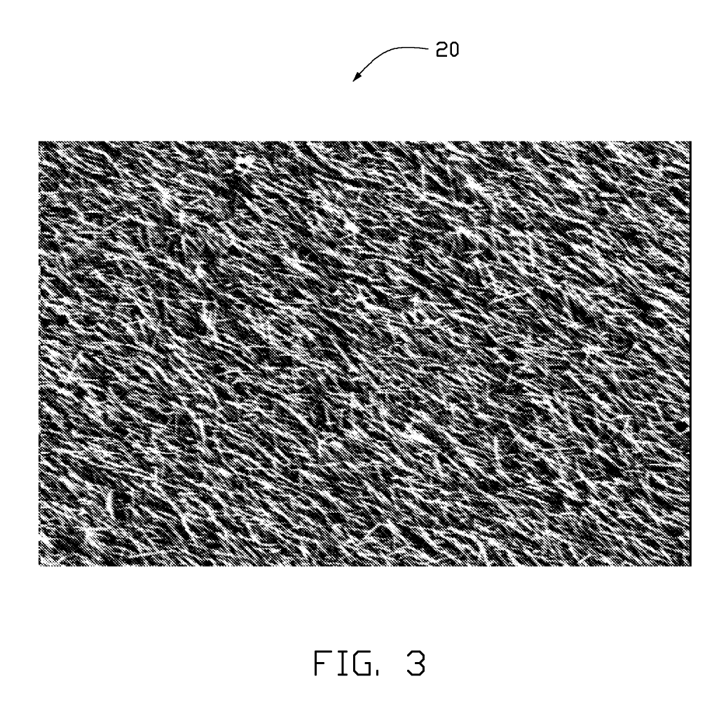

After removing the first substrate 10 and the second substrate 40 respectively from the nanowire film 20 and the thermoplastic polymer layer 50, the nanowire structure 100 including the thermoplastic polymer layer 50 and the nanowire film 20, is obtained. The nanowire film 20 can be further separated from the thermoplastic polymer layer 50. The nanowire film 20 thus has nanowires 12 with a lengthwise direction thereof along a substantially same direction. A scanned picture of the nanowire film 20 is shown in FIG. 3.

In order to be easily separated, a material of the first substrate 10 is different from that of the nanowires 12, and a material of the second substrate 40 is different from that of the first substrate 10.

The method detailed above is easier to carry out, and needs a shorter time.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A nanowire structure, comprising:
a thermoplastic polymer layer having a surface; and
a nanowire film arranged on the surface of the thermoplastic polymer layer, the nanowire film comprising a plurality of nanowires laid directly on the surface, the nanowires oriented along a substantially same direction.

2. The nanowire structure of claim 1, wherein the thermoplastic polymer layer is transparent.

3. The nanowire structure of claim 2, wherein the thermoplastic polymer comprises polymethyl methacrylate.

4. The nanowire structure of claim 1, wherein the nanowires are metallic nanowires.

5. The nanowire structure of claim 4, wherein a material of the nanowires is selected from a group consisting of nano-sized silver particles, nano-sized nickel particles, and nano-sized zinc oxide particles.

6. The nanowire structure of claim 1, wherein the nanowires are semi-metallic nanowires.

7. The nanowire structure of claim 6, wherein the nanowires are made of nano-sized silicon particles.

8. A method for making a nanowire structure, the method comprising:
providing a first substrate having a first surface;
growing a nanowire array on the first surface, the nanowire array comprising a plurality of nanowires;
providing a second substrate having a second surface and an opposite third surface;
applying a thermoplastic polymer solution on the second surface using a spin coating process, the thermoplastic polymer solution having an organic solvent and a thermoplastic polymer solute;
heating the second substrate to vaporize the organic solvent, thereby obtaining a thermoplastic polymer layer on the second surface;
combining the first substrate and the second substrate together with the nanowires facing the thermoplastic polymer layer;
compressing the combined the first and second substrates using a squeezing roller pair, the squeezing roller pair comprising a roller rolling on the third surface of the second substrate along a straight line; and
removing the first substrate and the second substrate to obtain a nanowire structure comprising the thermoplastic polymer layer and a nanowire film consisting of the nanowires laid directly on the thermoplastic polymer layer, the nanowires oriented along a substantially same direction.

9. The method of claim 8, further comprising a step of separating the nanowire film from the thermoplastic polymer layer.

10. The method of claim 8, wherein the organic solvent is toluene.

11. The method of claim 8, wherein the squeezing rolling pair further comprises a delivering belt to carry and deliver the combined first and second substrates, and another roller supporting the delivering belt.

12. The method of claim 8, wherein the thermoplastic polymer comprises polymethyl methacrylate.

13. The method of claim 8, further comprising heating the thermoplastic polymer layer to soften the thermoplastic polymer layer prior to adhering the nanowires to the thermoplastic polymer layer.

14. The method of claim 8, wherein the nanowires are metallic or semi-metallic nanowires.

15. A method for making a nanowire structure, the method comprising:
forming a plurality of nanowires on a first substrate;
forming a thermoplastic polymer layer on a second substrate;
combining the first substrate and the second substrate together with the nanowires facing the thermoplastic polymer layer;
compressing the combined the first and second substrates using a squeezing roller pair to adhere the nanowires to the thermoplastic polymer layer, the squeezing roller pair comprising a roller rolling on the second substrate along a straight line; and
removing the first substrate and the second substrate to obtain a nanowire structure comprising the thermoplastic polymer layer and the nanowires laid directly on the thermoplastic polymer layer, the nanowires oriented along a substantially same direction.
